(19) United States
(12) Patent Application Publication
(10) Pub. No.: US 2013/0296749 A1
(43) Pub. Date: Nov. 7, 2013

(54) MULTIFUNCTIONAL MASSAGE DEVICE

(71) Applicant: Fei-peng LIN, Hsinchu City (TW)

(72) Inventor: Fei-peng LIN, Hsinchu City (TW)

(21) Appl. No.: 13/798,108

(22) Filed: Mar. 13, 2013

(30) Foreign Application Priority Data
May 3, 2012 (TW) 101208316

(51) Int. Cl. A61H 15/00

(52) U.S. Cl. CPC A61H 15/0092
USPC 601/119

(57) ABSTRACT

A multifunctional massage device includes a main body and a massage stimulation roller. The main body is made in the form of a handle that has an end forming a support seat including joint holes for rotatably supporting the massage stimulation roller for free rotation of the massage stimulation roller and an opposite end forming a skin-scraping section that is curved and comprises a large-area opening formed therein. The massage stimulation roller has an outer circumferential surface on which a plurality of conic or pyramid projections is formed that is arranged in circumferential rows in order to form a massage section. The massage stimulation roller may be used to carry out a massaging operation through transcutaneous nerve stimulation, while the skin-scraping section functions to carry out a skin-scraping operation.

### TECHNICAL FIELD OF THE INVENTION

The present invention generally relates to an improved handheld massage roller, and more particularly to an improved multifunctional massage device that provides functions of transcutaneous never stimulation and skin scraping.

### DESCRIPTION OF THE PRIOR ART

It is commonly known that various handheld massage rollers are available in the market. However, these massage devices are usually of a single function. In addition, the structure designs of the rollers of these massage devices are often imperfect, rending the effect of massage they provide very limited. Since these known massage devices are not perfect, further improvement is necessary.

### SUMMARY OF THE INVENTION

The primary object of the present invention is to overcome the shortcomings of poor massage effect of the conventional handheld massage rollers and to include a function of skin scraping in order to provide a massage device that achieves the best of effect of massage and are of multiple functions.

The present invention provides a multifunctional massage device, which is a massage device featuring transcutaneous nerve stimulation and skin scraping. It is known clinically from human anatomy that through proper stimulation, never terminals will release a naturally secreted substance of human body, which is acetylcholine. Acetylcholine may help instantly relax muscle tissues so as to achieve an effect of relief and loosening for tired, strained, stiff, and painful and uncomfortable muscles and tendons. Long term use would be of help to improve blood circulation and also provide a function of enhancing metabolism of blood.

The present invention that provides the above discussed efficacies is a device composed of a main body and a massage stimulation roller. The main body is made in the form of a handle that has an end forming a support seat comprising joint holes for rotatably supporting the massage stimulation roller for free rotation of the massage stimulation roller and an opposite end forming a skin-scraping section that is curved and comprises a large-area opening formed therein. The massage stimulation roller has an outer circumferential surface on which a plurality of conic or pyramid projections is formed that is arranged in circumferential rows in order to form a massage section. The massage stimulation roller may be used to carry out a massaging operation through transcutaneous nerve stimulation, while the skin-scraping section functions to carry out a skin-scraping operation. The present invention is easy to carry and operate and causes no pain and no side effect and is suitable for all people, including both male and female and young and old people.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention in an assembled form.

FIG. 3 is a bottom side perspective view of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

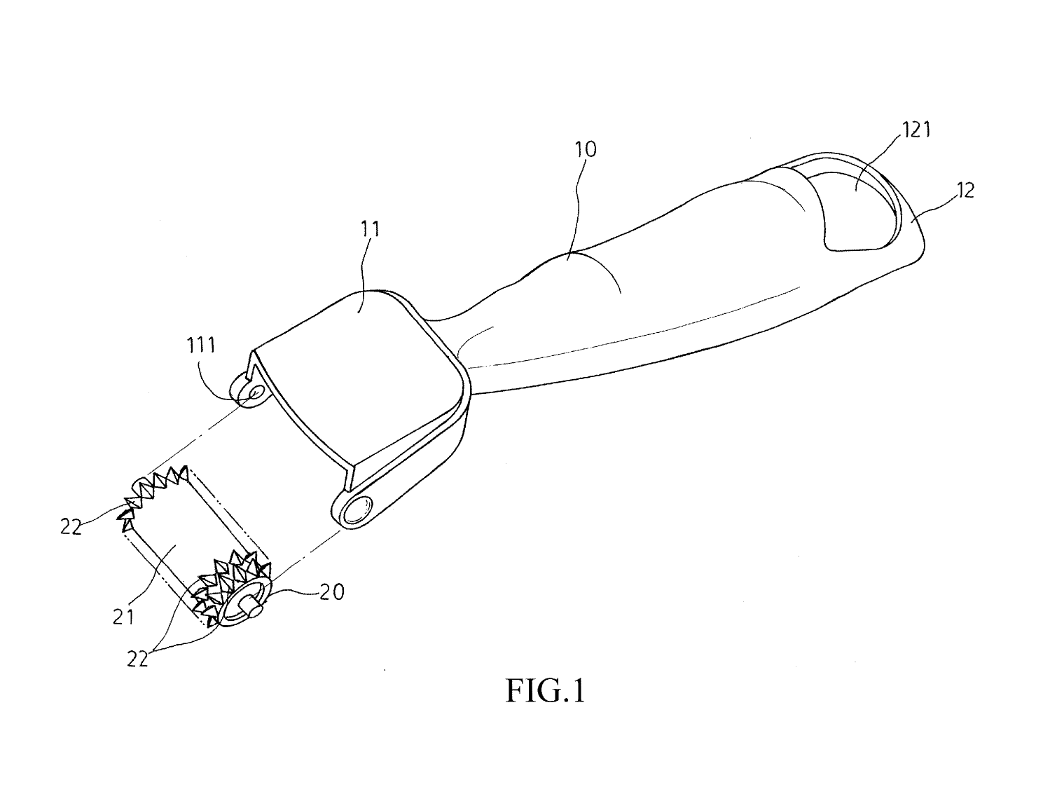

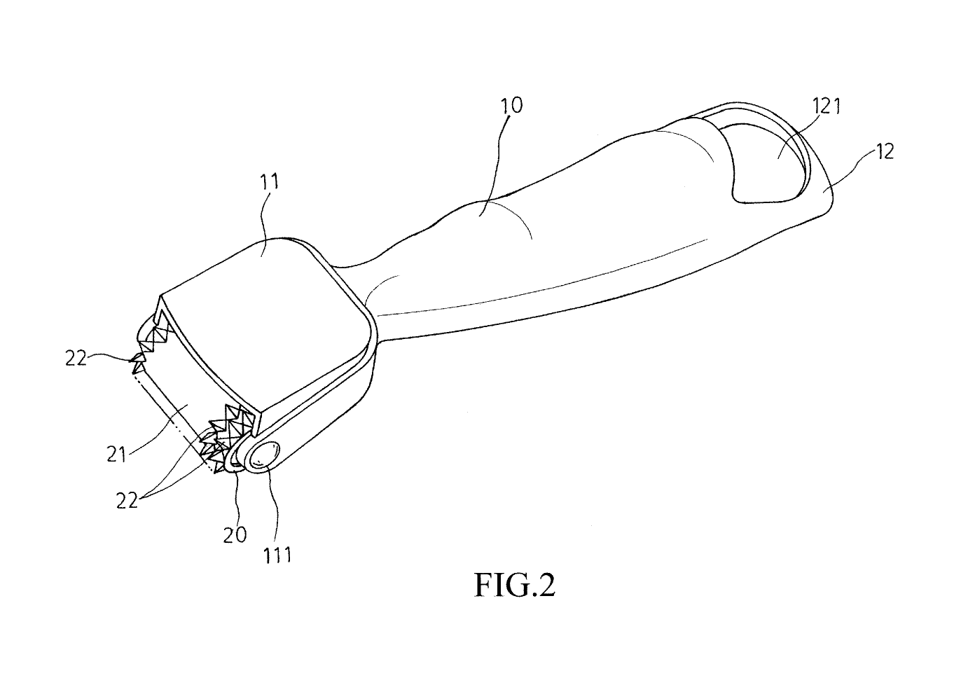

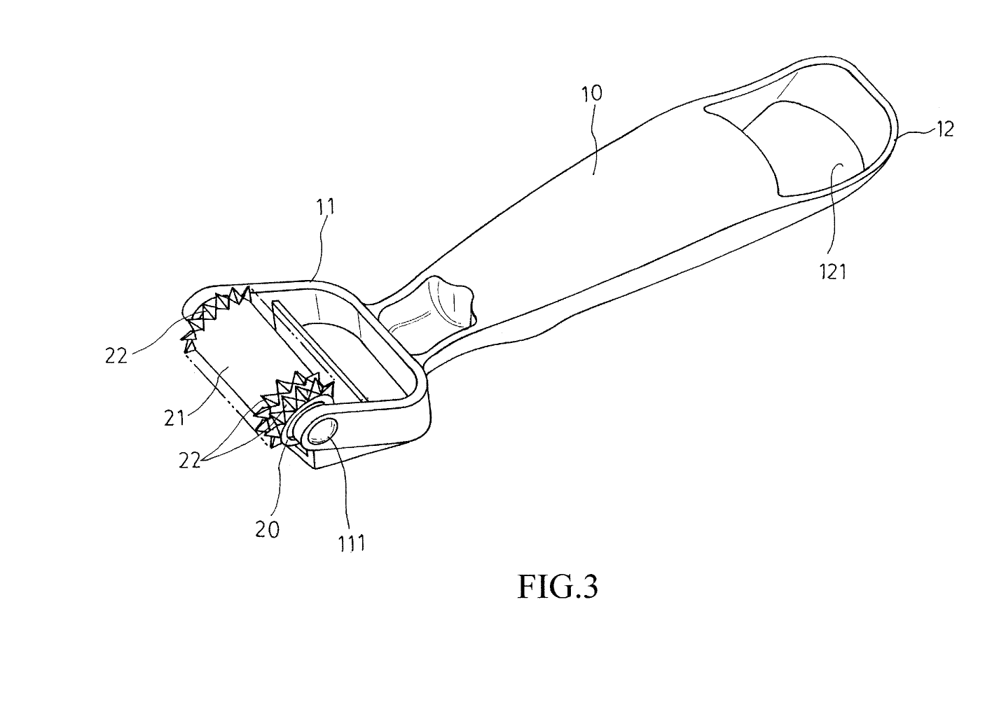

As shown in FIGS. 1-3, the present invention provides a multifunctional massage device that comprises a main body (10) and a massage stimulation roller (20). The main body (10) is made in the form of a handle having an end forming a support seat (11). The support seat (11) has two spaced arms each forming a joint hole (111). The main body has an opposite end that forms a curved skin-scraping section (12). A large-area opening (121) is formed in the skin-scraping section (12) for easily washing off contamination and dirt. The simulation roller (20) is received in the support seat (11) between the two arms and is rotatably coupled to the joint holes (111) for free rotation. The massage stimulation roller (20) has an outer circumferential surface forming a plurality of conic or pyramid projections (22) arranged circumferentially in multiple circumferential rows to form a massaging section (21). Each of the circumferential rows is formed of multiple projections (22) juxtaposing each other. The projections (22) are arranged in such a way that the apexes of the projections of adjacent circumferential rows are alternate to each other. With such an arrangement, the massage stimulation roller (20) can be used to achieve a massage effect of transcutaneous nerve stimulation, while the skin-scraping section (12) can be used to carry out a skin-scraping operation. The present invention is easy to carry and operate and causes no pain and no side effect and is suitable for both male and female and also suitable for young and old people.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multifunctional massage device, comprising a main body and a massage stimulation roller, the main body being made in the form of a handle having an end forming a support seat, which has two spaced arms each forming a joint hole, and an opposite end that forms a skin-scraping section that is curved and comprises a large-area opening formed therein, the massage simulation roller being received in the support seat by being rotatably coupled to the joint holes for free rotation, the massage stimulation roller comprising a plurality of pyramid projections arranged circumferentially in multiple circumferential rows to form a massaging section, each of the circumferential rows being formed of multiple projections juxtaposing each other.

2. The multifunctional massage device according to claim 1, wherein the projections are arranged in such a way that apexes of the projections of adjacent circumferential rows are alternate to each other.
